(19) United States
(12) Patent Application Publication
(10) Pub. No.: US 2025/0293920 A1
(43) Pub. Date: Sep. 18, 2025

(54) ALARM MANAGEMENT

(71) Applicant: Nokia Solutions and Networks Oy, Espoo (FI)

(72) Inventors: Riccardo Giorgio GEMELLI, Vimercate (IT); Sandra BARAO, Amadora (PT); Giuliano CORBETTA, Vimercate (IT); Stefania PEREGO, Vimercate (IT); Marco Andrea PISCHEDDA, Vimercate (IT)

(21) Appl. No.: 18/867,336

(22) PCT Filed: May 27, 2022
(86) PCT No.: PCT/EP2022/064400

§ 371 Date: Nov. 19, 2024

(51) Int. Cl. H04L 41/0681; H04L 41/147; H04L 41/16

(52) U.S. Cl. CPC H04L 41/0681; H04L 41/147; H04L 41/16

(57) ABSTRACT

According to an example aspect of the present invention, there is provided an apparatus configured to store a set of parameters of a machine learning classifier configured to predict networked alarms, the set of parameters comprising at least one maximum time interval, process a first alarm signal sequence originating in a networked environment, consecutive alarms comprised in the first alarm signal sequence occurring at most a time interval comprised in the at least one maximum time interval from each other, and predict, using the set of parameters of the machine learning classifier and the machine learning classifier, based on the first alarm signal sequence, at least one second alarm signal to occur during a first time interval.

### FIELD

The present disclosure relates to management of alarms in a networked system, such as, for example, a communication network.

### BACKGROUND

Fault management systems in communication networks are used for detection, identification, managing and/or fixing of network faults, that is events where network functioning impairment occurs due to hardware or software issues in network elements that cause them to be unavailable and/or to function at degraded performance levels for providing network services.

To communicate information on faults, network elements or network management systems raise alarms representing symptoms that can be observed of a potential fault, to notify for the likely presence of faults. Several alarms may appear in a cascade, since a single original fault may in turn cause one or more further events which generate alarms in the system.

As consequence of fault events, a large number of alarms may be produced as sequences, affecting different parts of the same equipment, in the case of intra-node failures, or distinct equipments in the case of inter-node failures or cross-domain failures.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to store a set of parameters of a machine learning classifier configured to predict networked alarms, the set of parameters comprising at least one maximum time interval, process a first alarm signal sequence originating in a networked environment, consecutive alarms comprised in the first alarm signal sequence occurring at most a time interval comprised in the at least one maximum time interval from each other, and predict, using the set of parameters of the machine learning classifier and the machine learning classifier, based on the first alarm signal sequence, at least one second alarm signal to occur during a first time interval.

According to a second aspect of the present disclosure, there is provided a method comprising storing, in an apparatus, a set of parameters of a machine learning classifier configured to predict networked alarms, the set of parameters comprising at least one maximum time interval, processing a first alarm signal sequence originating in a networked environment, consecutive alarms comprised in the first alarm signal sequence occurring at most a time interval comprised in the at least one maximum time interval from each other, and predicting, using the set of parameters of the machine learning classifier and the machine learning classifier, based on the first alarm signal sequence, at least one second alarm signal to occur during a first time interval.

According to a third aspect of the present disclosure, there is provided a non-transitory computer readable medium having stored thereon a set of computer readable instructions that, when executed by at least one processor, cause an apparatus to at least optimize a set of parameters of a machine learning classifier configured to predict networked alarms, the set of parameters comprising at least one maximum time interval, provide, to the optimization of the set of parameters of the machine learning classifier, plural networked alarm sequences as training data, the plural networked alarm sequences not being all of equal length, consecutive alarms comprised in the networked alarm sequences occurring at most a time interval comprised in the at least one maximum time interval from each other.

According to a fourth aspect of the present disclosure, there is provided an apparatus comprising means for storing a set of parameters of a machine learning classifier configured to predict networked alarms, the set of parameters comprising at least one maximum time interval, processing a first alarm signal sequence originating in a networked environment, consecutive alarms comprised in the first alarm signal sequence occurring at most a time interval comprised in the at least one maximum time interval from each other, and predicting, using the set of parameters of the machine learning classifier and the machine learning classifier, based on the first alarm signal sequence, at least one second alarm signal to occur during a first time interval.

According to a fifth aspect of the present disclosure, there is provided a non-transitory computer readable medium having stored thereon a set of computer readable instructions that, when executed by at least one processor, cause an apparatus to at least store a set of parameters of a machine learning classifier configured to predict networked alarms, the set of parameters comprising at least one maximum time interval, process a first alarm signal sequence originating in a networked environment, consecutive alarms comprised in the first alarm signal sequence occurring at most a time interval comprised in the at least one maximum time interval from each other, and predict, using the set of parameters of the machine learning classifier and the machine learning classifier, based on the first alarm signal sequence, at least one second alarm signal to occur during a first time interval.

According to a seventh aspect of the present disclosure, there is provided a computer program configured to cause an apparatus to perform at least the following, when executed: store a set of parameters of a machine learning classifier configured to predict networked alarms, the set of parameters comprising at least one maximum time interval, process a first alarm signal sequence originating in a networked environment, consecutive alarms comprised in the first alarm signal sequence occurring at most a time interval comprised in the at least one maximum time interval from each other, and predict, using the set of parameters of the machine learning classifier and the machine learning classifier, based on the first alarm signal sequence, at least one second alarm signal to occur during a first time interval.

### BRIEF DESCRIPTION OF THE DRAWINGS

FIG. 1 illustrates an example system in accordance with at least some embodiments of the present invention;

FIG. 2A illustrates alarm prediction in accordance with at least some embodiments of the present invention;

FIG. 2B illustrates alarm prediction in accordance with at least some embodiments of the present invention;

FIG. 2C illustrates training of the separate predictors;

FIG. 3 illustrates an example apparatus capable of supporting at least some embodiments of the present invention;

FIG. 4 is a flow chart in accordance with at least some embodiments of the present invention, and

FIG. 5 is a flow graph of a method in accordance with at least some embodiments of the present invention.

### EMBODIMENTS

Managing alarm traffic presents challenges due to the quantity of alarms, and difficulty in interpreting them in a timely manner to minimise impact on functioning of the communication network. A machine learning solution is employed in predicting the occurrence of alarms in a networked environment, based on alarms which have already been generated in the networked environment. Based on the predicted alarm, actions may be taken already before the predicted alarm occurs, such as re-configuring the networked environment to reduce the likelihood of the predicted alarm actually occurring, and/or a work order for maintenance personnel may be transmitted to initiate recovery from the predicted alarm already before it occurs. While a communication network is primarily discussed herein, technical principles disclosed herein are applicable also to other networked environments which generate alarms and where management of alarms is needed. Examples of such other networked environments include equipment networks installed in an aircraft, such as commercial aircraft, and industrial automation system networks.

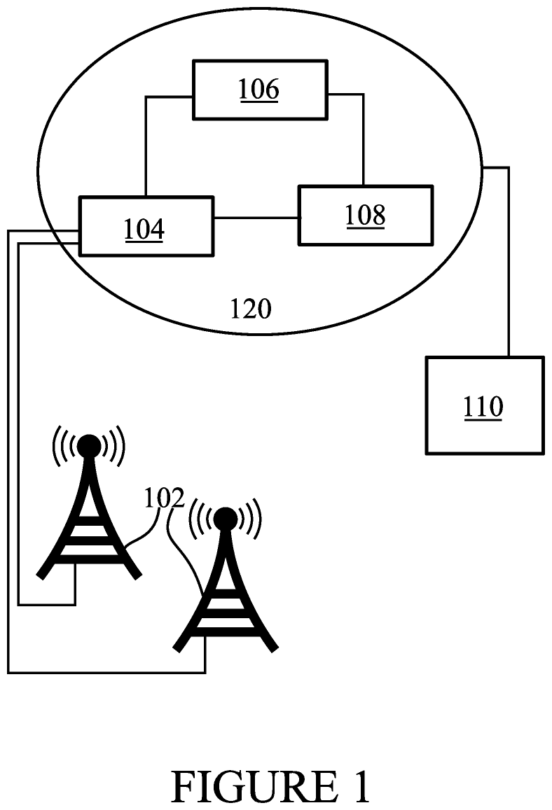

FIG. 1 illustrates an example system in accordance with at least some embodiments of the present invention. The illustrated system is a wireless communication network, which comprises a radio access network wherein are comprised base stations 102, and a core network 120 wherein are comprised core network nodes 104, 106 and 108. Depending on the technology used, base stations 102 may be referred to as access points, access nodes or node-b, eNb or gNb nodes. A network may have dozens, hundreds or even thousands of base stations. Examples of wireless communication networks include cellular communication networks and non-cellular communication networks. Cellular communication networks include wideband code division multiple access, WCDMA, long term evolution, LTE, and fifth generation, 5G, networks. Examples of non-cellular wireless communication networks include worldwide interoperability for microwave access, WiMAX, and wireless local area network, WLAN, networks.

Core network nodes 104, 106, 108 may comprise, for example, mobility management entities, MMEs, gateways, subscriber registries, access and mobility management functions, AMFs and serving general packet radio service support nodes, SGSNs. The core network nodes are logical entities, meaning that they may be physically distinct stand-alone devices or virtualized network functions, VNFs, run on computing substrates. In some network technologies, the radio access network comprises, in addition to base stations, also base station controllers.

Fault management system, FMS, 110 is configured to receive alarms from the network, either the core network only, or from both the core network and the radio-access network. Alarms from the radio access network may be received in FMS 110 via core network 120. Alarms may be issued by logical or physical nodes, for example, an MME may send an alarm when criteria for sending one are fulfilled, for example, when its latency exceeds a limit. Likewise, if the MME operates as a VNF on a computing substrate, the computing substrate may issue an alarm to FMS 110 when it detects an issue with its performance, such as a hard drive failure, memory checksum fail, interruption of power supply and consequent fail-over to battery power, or overloading. In particular, a cascade of overloading alarms may be generated when computing substrates are overloaded as a result of receiving a computation load of another, failed, computing substrate in the same network. Likewise, a fire in a server space may affect plural computing substrates and the VNFs they run, which will fail in a sequence as a result of heat generated by the fire.

FMS 110 is configured to open work orders to respond to alarms. For example, a work order may instruct maintenance personnel to attend to replacing a faulty part in a device comprised in the network environment. A challenge in decisions on transmitting work orders is that they have to be generated in a timely manner avoiding doing this too early, for example as a response to a self-restoring temporary fault. On the other hand where a work order is needed it should be transmitted as soon as possible, to limit the extent of an impact the fault has on network services. It is consequently of considerable interest to understand sequences of alarms in a comprehensive and timely manner. As a size of the network environment increases, the number of alarms generated tends to increase, increasing also the technical challenge in responding to the alarms in a timely and productive manner.

As will be herein disclosed, a machine learning solution is employed to predict the occurrence of future alarms in the network environment. This provides an advantage in time in that a response to the predicted alarm may be initiated already before the predicted alarm occurs, providing the technical effect of reducing or even eliminating the time the fault underlying the predicted alarm impacts performance of the networked environment. In some embodiments, the machine learning solution is trained to predict not only the occurrence of alarms, but also necessary responses to the alarms, such that work orders may be transmitted automatically, as a response to the prediction and before the associated alarm even occurs, to only those alarms which really need intervention. Thus work orders are not transmitted for self-healing alarms, for example. Such training is possible by accumulating training data from historical maintenance records of the networked environment in question. A machine learning algorithm may learn to predict, based on patterns in arriving alarms, when an alarm is likely to be self-healing or of such limited effect on performance, that a work order is not necessary. Expressed in other words, FMS 110 may be configured to predict future alarms that warrant generation of a work order, and to predictively transmit the work orders before the predicted alarm occurs. Thus FMS 110 provides predictive information on the technical state of the networked environment which enables timely actions to maintain the networked environment in working condition.

The used machine learning solution may be a classifier based on association rules, CAR. Examples of association rule-based machine learning algorithms include the apriori algorithm, the eclat algorithm, the frequent pattern, FP, growth algorithm, and the ASSOC and OPUS-search algorithms. Alternatively, or additionally, the used machine learning solution may comprise an artificial neural network, such as a convolutional artificial neural network, a recurrent artificial neural network, for example.

When using an association rules-based machine learning classifier or neural network, the training set may comprise a plurality of alarms, each alarm having at least one, at least two, at least three, or all of the following attributes: an alarm equipment type/vendor, which is the main information item for alarm aggregation, alarm raise and/or alarm clear timestamps, alarm type, alarm severity (e.g. critical, major, minor, warning or notification), affected equipment part category, affected sub-item in the spatial scope (e.g. if the alarm is at equipment, slot or port, with related IDs), ticket (alarm labelled with trouble ticket and ID, or empty if not labelled), and work order (alarm labelled with a WorkOrder and ID or empty if not so labelled).

Once the system is trained and used in inference mode with a live networked environment, incoming alarms will have same attributes as in training with the exception that ticket and work order fields are not initially provided, but are added as needed by the FMS 110. Additionally, work order information may be predictively provided to the predicted alarms which have not yet occurred, automatically without human intervention, as described above.

FMS 110 may store the trained and/or selected parameters of the machine learning classifier and apply these parameters to a sequence of incoming alarms forming a first alarm sequence. In the first alarm sequence, consecutive ones of the individual alarms comprised in the first alarm sequence are temporally separated by at most a maximum time interval which corresponds to a maximum causal distance in the networked environment. The FMS will then predict at least one second alarm signal based on the first alarm sequence and the trained classifier parameters. In particular, the predicted at least one second alarm is predicted to occur during a time interval, that is, the prediction predicts not only the occurrence but also an estimate of the time when the alarm will occur. As noted above, the FMS may also predict whether a work order is needed for the predicted, not yet occurred alarm.

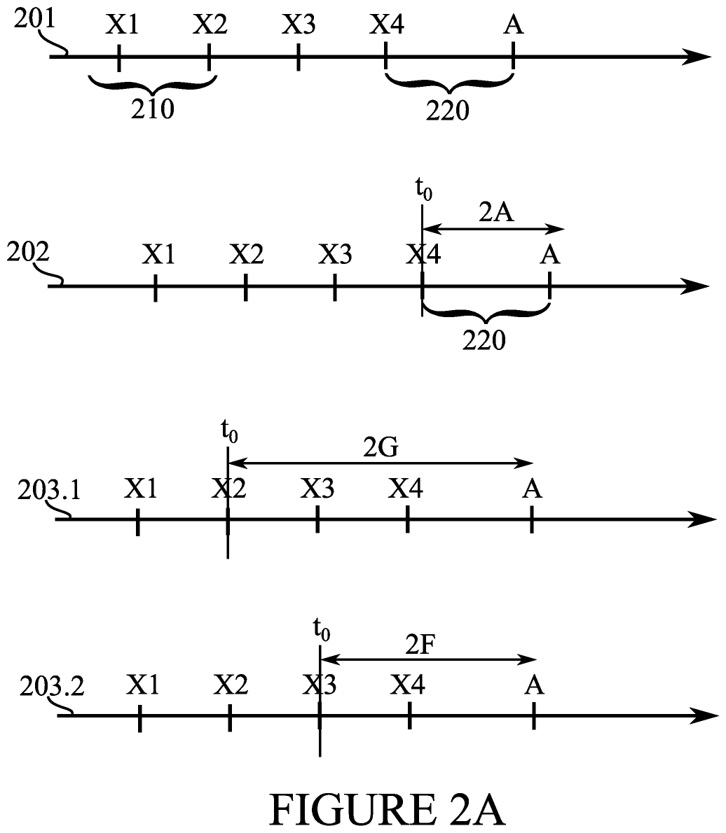

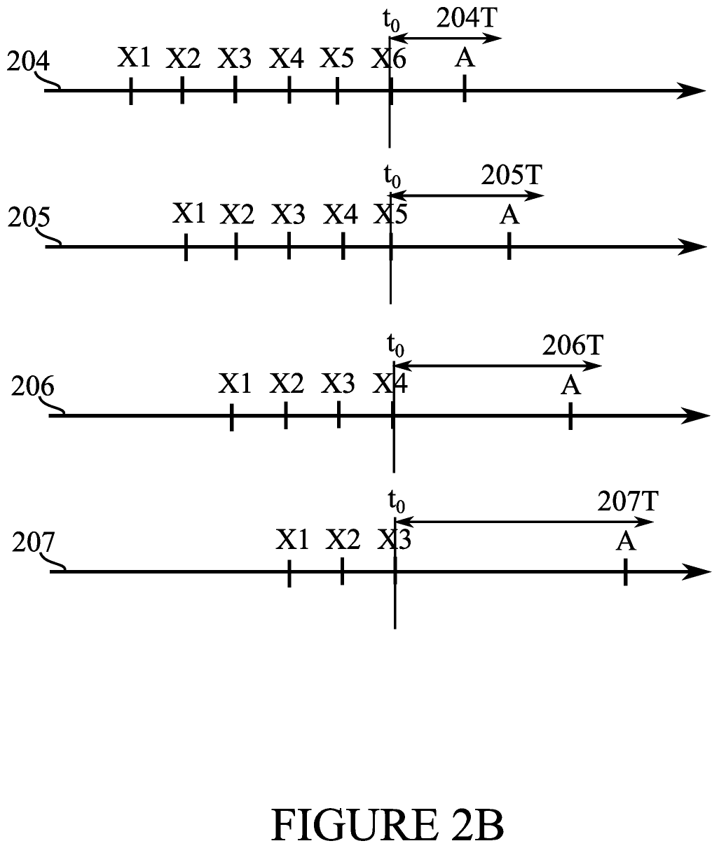

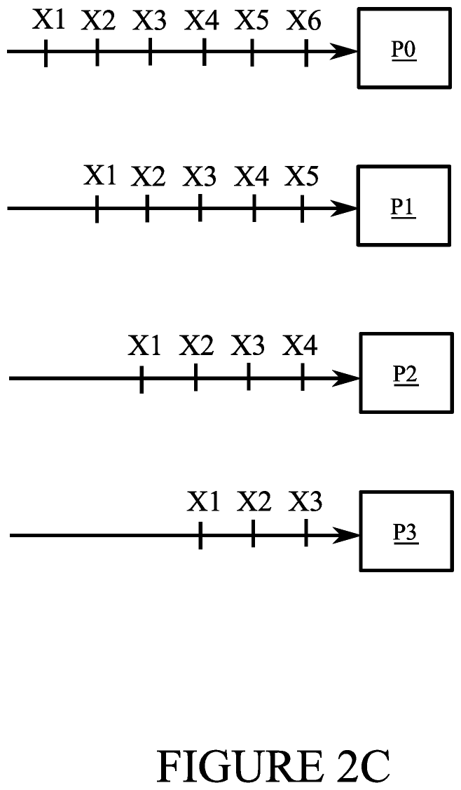

While the entire first alarm signal sequence is predictive of the at least one second alarm, also an initial part of the first alarm signal sequence may in itself be predictive of the at least one second alarm. This will be discussed in more length in connection with FIG. 2A. More generally, a subset, such as a proper subset, of the first alarm sequence may be used to predict the at least one second alarm.

For use in the machine learning classifier, incoming alarms may be transformed into an invariant part and a variant part, such that the invariant part is not predictive of a time instant when the at least one second alarm signal occurs and the variant part is predictive of the time instant when the at least one second alarm signal occurs. The invariant part will be referred to herein as a core summarization, described by a core feature set and the variant part as a full summarization, described by a full feature set. The core feature set is a proper subset of the full feature set. The core and full summarizations will be discussed in more length herein below.

In some embodiments, FMS 110 is configured to perform the prediction of the at least one second alarm signal such that it generates separate predictions for each of a plurality of future time intervals concerning the occurrence of the at least one second alarm signal. Each of the predictions may be assigned a likelihood describing the probability of the predicted alarm occurring during the respective time interval. For example, a first prediction may be generated for a time interval starting from the present time to and extending to t₀+delta_t, a second prediction may be generated for a time interval starting from time t₀ and extending to t₀+2×delta_t, and a third prediction may be generated for a time interval starting from time t₀ and extending to t₀+3×delta_t. Time t0 may correspond to the present calendar day and delta_t may correspond to 24 hours, for example.

FIG. 2A illustrates alarm prediction in accordance with at least some embodiments of the present invention. The figure comprises three time axes 201, 202 and 203. Time advances from the left toward the right in each one of the time axes. Time axis 201 represents training data used in training the parameters of the machine learning classifier for predicting alarms. The training data may be built in an initial stage of the process. In detail, a sequence of alarms comprising alarms X1, X2, X3, X4 and A are displayed. Naturally, the number of alarms in a sequence need not be five but may be smaller, or greater, than five. The training process enables the classifier to predict alarm A, when a sequence {X1, X2, X3, X4} is observed during inference mode. Consecutive ones of the alarms in sequence {X1, X2, X3, X4} are within a maximum time interval 210 of each other. Maximum time interval 210 represents a maximum causal distance in time in the networked environment in question, and may be determined experimentally, in the training process, or initially experimentally and subsequently updated in the training process, or a re-training process, of the machine learning parameters. In other words, alarm X2 is caused by alarm X1, and alarm X3 in turn by alarm X2, and alarm X4 is caused by alarm X3, for example. Alternatively, for example, X1 may cause both X2 and X3, and then X3 may in turn cause X4. In general, there exist causal relationships between the alarms in the sequence. This forms a cascade of alarms. Alarm A is caused most immediately by alarm X4, although as a whole it is comprised in the overall cascade of alarms.

An alarm sequence is observed by recording incoming alarms which fall within the maximum time interval 210 of each other, thus forming a sequence. Once no alarm follows the most recently received alarm in the sequence within the maximum time interval 210, the entire alarm sequence has been received. Subsequent alarms are then either single alarm not comprised in a sequence, or comprised in another sequence of alarms. Once a complete sequence of alarms has been defined, a pattern causal length of the sequence may be determined as the time elapsing between the first and the last alarms in the observed sequence.

In some embodiments, plural maximum time intervals may be employed, such that a first time interval from among the plural maximum time intervals may apply to a largest allowable time interval between the first two alarms in a sequence of alarms, a second time interval from among the plural maximum time intervals may apply after that to the a largest allowable time interval between the second and third alarms in the sequence of alarms, and so on. Yet further, additionally or alternatively, it is possible that the maximum time interval after a certain alarm depends on the type of the alarm, for example, after a critical-type alarm the immediately succeeding alarm in the sequence must arrive sooner than after a non-critical alarm to be assumed to be causally linked. This is useful, since certain kinds of alarms may be expected to result in further alarms in a cascade of alarms faster than other kinds. Which types of alarm are expected to result in a subsequent alarm sooner depend on specific characteristics of the networked environment in question. This enhances the predictive ability of the alarm prediction system.

Maximum time interval 210 may be one day, for example, or an hour, or two days, for example. Time interval 220 is the time after alarm X4 that alarm A is expected to occur. This may exceed the maximum time interval 210, since alarms not included in the training data may take place between alarm X4 and alarm A. As failure cascades do not always unfold in the precisely same timing due to component and workload variations, the time intervals between alarms in the sequences may also exhibit some variation. Sequence {X1, X2, X3, X4} is an alarm sequence used for predicting further alarms and does not necessarily comprise all the alarms generated by the networked environment during this time. Indeed, the system may be configured to remove certain kinds of alarms, such as notifications, before feeding alarms to the machine learning classifier.

The alarm sequence on time axis 201 may also indicate that alarm A was associated with a work order, enabling prediction not only of the occurrence of alarm A but also of the associated work order. The work order may be an order to replace a failed hardware part, for example. Alarm A may additionally, or alternatively, be associated with an instruction to automatically perform a modification in the networked environment, such as hand-over of a workload of a logical node to another logical node. The handing over of the workload may be useful in case protocol connections, for example, are handed over to another node before a node fails, enabling the protocol connections to be protected from being severed by the failure which generates alarm A.

The incoming alarm data fed to the machine learning classifier may be pre-processed by removing from it alarms known to not be associated with cascades of alarms, as noted above. Further examples of such alarms are alarms which do not occur within maximum time interval 210 of any preceding or succeeding alarm. This pre-processing is done in both the training phase and in the inference phase when predictions are made concerning the future. In some embodiments, notification-level alarms are also removed from the data to be used in training and inference.

Alarms may be treated as to their timing based on their timestamps indicating when they were generated, rather than times when they are received in FMS 110. This removes from the prediction process uncertainties generated from possible jitter in the networked environment. In other words, the maximum time interval 210, for example, is applied to timestamps indicating when the alarms were generated, rather than to times of receipt of the alarms in FMS 110. Indeed in case nodes have failed in the networked environment, times of travel of messages, such as alarms, may be unpredictable.

Time axis 202 represents the inference mode, where t₀ is the current time. Alarm sequence {X1, X2, X3, X4} has been observed in the past, wherefore, based on training using the training data illustrated in time axis 201, FMS 110 predicts alarm A to occur in the future, during time interval 2A. When t₀ is close t₀ the occurrence of X4, that is, after t₀ alarm X4 has been observed by the system, and the interval 2A may be relatively brief. Conceptually this may be thought of as A occurring at a time instant which is time interval 220 after alarm X4. As the entire sequence {X1, X2, X3, X4} has been observed, the occurrence of alarm A may be predicted with a fairly high likelihood. While discussed here as a high likelihood, this in practice will depend on the alarm cascade data generated in the networked environment. In terms of FIG. 2A, it is assumed that sequence {X1, X2, X3, X4} is highly predictive of alarm A although this cannot be categorically stated of all networked environments.

FMS 110 may generate separate predictions for each of a plurality of future time intervals such as time interval 2A concerning the occurrence of alarm A. For example, sequence {X1, X2, X3} might have been used to predict an occurrence of A during a time interval 2F which is longer than time interval 2A, or which begins later than the starting time of time interval 2A.

In each of the separate predictions, FMS 110 may be configured to use different cut-off points for choosing the input data in terms of alarm data generated by the networked environment. In general, the later is the time period for which the prediction is being generated, the sooner is the cut-off point that begins the time period from which alarms are included in the input data. In effect, distinct machine learning classifiers may be used for generating the predictions for the respective distinct time intervals. In particular, FMS 110 may be configured to search for only initial parts of input alarm sequences when the time interval for which a specific prediction is being generated is in the future. In other words, the training may be conducted with a longer input alarm sequence, and prediction in inference mode may be conducted using an initial part only of the determined predictive input alarm sequence to generate predictions for time intervals which are in the future.

Time axis 203.1, and 203.2 represent inference mode, where t₀ is again the current time. In the situation of time axis 203.1, alarms X1 and X2 of sequence {X1, X2, X3, X4} have been received and, FMS 110 generates a prediction that alarm A will occur during time interval 2G, as it occurs after the initial part {X1, X2} of sequence {X1, X2, X3, X4}. Further, the time elapsed from X2 to alarm A in training data along time axis 201 is the same time as between X2 in time axis 203.1 and alarm A in time interval 2G. This prediction may be performed already when an overall time duration of sequence {X1, X2, X3, X4} from beginning to end (X1 to X4) has not yet elapsed from the first alarm, X1, in the sequence, in other words, the prediction may be generated when the sequence is still ongoing and not yet fully received, but when an initial part of it has been received. Also expressed in another way, the initial part {X1, X2} is used as a predictive input alarm sequence in the predictor for time interval 2G. For time interval 2F, time axis 203.2, the corresponding predictive input alarm sequence is {X1, X2, X3}. In general, the later in time is the time interval for which a prediction is generated, the shorter is the initial part of the input alarm sequence that is used in generating the prediction.

Compared to the situation in time axis 202, the prediction in the situation on time axis 203.1, and 203.2 may be allocated a lower likelihood, since it is less certain because it is based on a shorter sequence of incoming alarms. However, the timing of alarm A, if it occurs according to the prediction, may be fairly dependable. As such, a work order or an instruction to automatically perform a modification in the networked environment may be allocated to alarm A predictively in both the case of time axis 202 and the case of time axis 203.1 and 203.2, if alarm A was associated with a work order or modification instruction in the training data of time axis 201.

Where FMS 110 allocates a work order or modification instruction to predicted alarm A in the case of time axis 203.1 or 203.2, FMS 110 may be configured to cancel the work order or modification instruction in case the entire sequence {X1, X2, X3, X4} is not received. For example, in case alarm X3 is not received after the prediction, within the maximum time interval 210 from alarm X2, the sequence will not be received and the prediction made based on the initial part of the sequence, {X1, X2} may have been wrong. Such a wrong prediction may be cancelled along with its modification instruction or work order. A prediction based on a subset of the entire sequence may also expire responsive to a new prediction being made, based on a larger subset of the sequence, of the same alarm. The earlier prediction has then become redundant as the new prediction, based on a longer sequence of alarms, is likely to be more reliable. An expired prediction may be removed.

In some embodiments, outstanding predictions are, in at least some embodiments, not cancelled due to the arrival of a longer sequence, instead the followed policy is used rather, that an outstanding prediction is cancelled when either the predicted alarm fails to occur within the predicted time interval, or the predicted alarm occurs before the end of the predicted time interval. The reason for this behaviour is that even though the system knows the fact that different alarm subsequences are related, each prediction is trained independently on its sub-sequence and thus each prediction has its own validity also independently from others.

In addition, in these embodiments not cancelling predictions due to the arrival of a longer sequence is useful in building a validation of prediction, and thus creating the ground truth for retraining. For example, system behaviour may be the following: subsequence1 {X1, X2, X3} may lead to prediction of A in future interval [0,T1]since it is matched by a rule learnt by the classifier during training (for instance something like {X1, X2, X3}→A [0,T1]).

Then a new alarm X4 defines a longer subsequence {X1, X2, X3, X4}, but no corresponding rule exists (for instance we have {X1, X2, X3}→A [0,T1], {X1, X2, X3, X5}→A [0,T2] but no rule for sequence {X1, X2, X3, X4}). Upon reception of X3 the prediction is {X1, X2, X3}→A [0,T1] Upon reception of X4 the prediction is “no predicted alarm” but the previous prediction remains still active ({X1, X2, X3}→A [0,T1]) and will be cancelled when T1 is elapsed or A occurs before T1.

In some embodiments, in the case of time axis 203.1 or 203.2 and predicting based on an initial part only of an input alarm sequence, and not the entire sequence of alarms, and the likelihood assigned to the prediction consequently being low, FMS 110 is configured to transmit to the networked environment an instruction to perform a modification which is only a part of the modification that a prediction with higher likelihood would prompt. This may in general be done also more broadly, when the likelihood of the prediction is below a pre-defined threshold value, regardless of the reason why the likelihood of the prediction is low. For example, if in case a high-likelihood prediction of alarm A would trigger hand-over of all protocol connections of a node that alarm A would involve, a lower-likelihood prediction of alarm A triggers a hand-over of a part only, such as half, of the protocol connections of the node. This represents a middle ground between rescuing the protocol connections on the one hand, and reducing a signalling load in the network environment on the other hand, since the hand-overs may require a lot of signalling. In some embodiments, if the likelihood of the prediction later increases, the complete modification may be conducted, such as hand-over of all the protocol connections if more of the predictive alarm sequence is received. In terms of time axis 203.1 or 203.2, this may mean receipt of alarm X3 within the maximum time interval 210 of alarm X2.

In some embodiments, the plural time intervals for which the predictions are generated are overlapping in the sense that they begin at the same time instant, and end at different time instants. For example, the plural time intervals may be (t₀, T1), (t₀, 2×T1), (t₀, 3×T1), (t₀, 4×T1) and (t₀, 5×T1). Notice that in this model t₀, N×T1 represents the occurrence of A which is the same for all N while it t₀ (present) that is moving on time axis. The likelihood of the alarm occurring in the interval thus increases with the length of the time interval in these embodiments, since latter ones of the intervals include the earlier ones. In general, when generating predictions for plural time intervals separately, each time interval may be associated with a distinct machine learning classifier, trained with distinct training data relevant for the time interval concerned.

A human user may be presented with the prediction, or predictions, made by FMS 110 and the work orders and/or modification instructions assigned to the prediction(s). The human user may then have a possibility to cancel the work orders and/or modification instructions before they're implemented in or for the networked environment, based on his judgement of the prevailing situation.

Alarms may be defined in both the training and inference phases using more than one alternative set of features. An alarm can be characterized by its features, such as the node, physical or virtual, which the alarm involves, its severity, a timestamp indicating when the alarm was generated, and so on. In some systems, an alarm may be a fairly complex data structure comprising over a dozen features. If training is done using all the features, a full feature set is used which results in a detailed prediction system. On the other hand, a matching alarm sequence in the input may be seen less frequently if each alarm has to match a large number of features to qualify as being in the sequence. Instead of a full feature set, it is possible to use a core feature set where only one, or a few features are present in the training and inference phases, such as the node type and/or alarm severity. The detected number of alarm cascades matching the alarm sequences in training data is then much higher, since more alarms will qualify as the criteria are looser. In terms of a single predicted alarm at the core feature set accuracy, it may be the predicted result of more than one input alarm sequence expressed in a core feature set resolution. In other words, an alarm may have more than one possible underlying cause. Expressing a sequence of alarms using the full and core feature sets amounts to transforming the alarm signal sequence into an invariant part which is not predictive of a time instant when the at least one second alarm signal occurs and a variant part which is predictive of the time instant when the at least one second alarm signal occurs. Core feature sets of two alarm sequences are described in the following table:

| | Occurrence | | | | | Core feature |
|---|---|---|---|---|---|---|
| Name | (TS) | Type | Severity | Activation | Duration | set |
| Pattern 1 | | | | | | 1M, 2M, 3C |
| A1 | TS1, TS4, TS5 | 1 | M | 3 | 60 m | |
| A2 | TS2 | 2 | M | 1 | 30 m | |
| A3 | TS3, TS6 | 3 | C | 2 | 120 m | |
| Pattern 2 | | | | | | 1M, 3C, 5C |
| A1 | TS1, TS4 | 1 | M | 2 | 40 m | |
| A3 | TS3, TS6 | 3 | C | 2 | 70 m | |
| A5 | TS2, TS5 | 5 | C | 2 | 100 m | |

The table describes two patterns, Pattern 1 and Pattern 2. Pattern 1 is a sequence of six alarms, the six alarms being of three different types A1, A2 and A3 which occur at the timestamps, TS, indicated in the table. In other words, Pattern 1 is comprised of the sequence {A1(TS1), A2(TS2), A3(TS3), A1(TS4), A1(TS5), A3(TS6)}. Alarm type A1 is of major, M, severity and lasts 60 minutes. Alarm type A2 is of major severity and lasts 30 minutes, while alarm type A3 is of critical, C, severity and lasts 120 minutes.

Pattern 2 is comprised, as indicated in the table, of the sequence {A1(TS1), A2(TS2), A3(TS3), A1(TS4), A1(TS5), A3(TS6)}. Alarm types A1 and A3 are the same as in Pattern 1, albeit with durations in this pattern of 40 minutes and 70 minutes, respectively, and alarm type A5 is of critical severity and duration 100 minutes. The durations may be expressed and used at an accuracy of ten minutes, for example, such that a duration of 11 minutes would match a duration of 10 minutes.

The core feature set, including here only type and severity, of Pattern 1 is thus 1M, 2M, 3C, and the core feature set of Pattern 2 is 1M, 3C, 5C. The full feature set of Pattern is 1M_3_60, 2M_1_30, 3C_2_120, and the full feature set of pattern 2 is 1M_2_40, 3C_2_70, 5C_2_100. Specifically, the sequence of alarms of Pattern 1, expressed using the core feature set, is {1M, 2M, 3C, 1M, 1M, 3C}. Correspondingly, the sequence of alarms of Pattern 2, expressed using the core feature set, is {1M, 5C, 3C, 1M, 5C, 3C}. The sequence of alarms of Pattern 1, expressed using the full feature set, is {1M3_60, 2M_1_30, 3C_2_120, 1M_3_60, 1M_360, 3C_2_120}. Correspondingly, the sequence of alarms of Pattern 2, expressed using the full feature set, is {1M_2_40, 5C_2_100, 3C_2_70, 1M_2_40, 5C_2_100, 3C_2_70}.

FIG. 2B illustrates alarm prediction in accordance with at least some embodiments of the present invention. Time advances from the left toward the right, and T₀ denotes the present time, as in FIG. 2A. An alarm sequence {X1, X2, X3, X4, X5, X6} is used to predict alarm A and its associated modification instruction and/or work order. The sequence may correspond, for example, to Pattern 1 or Pattern 2 discussed above. The sequence may be expressed using the full feature set or the core feature set, for example. In FIG. 2B on all time axes the last alarm is aligned to t0. This is because the causal relation between alarms of the first sequence {X1, X2, X3, X4, X5, X6} and A is related to time measure with timestamps in the network. Than is also possible that we receive those alarms with a delay and in “our” time there a displacement between present time in “our” time and alarm timestamps. In other words, there may be a delay between receipt of an alarm and a prediction based at least in part on that alarm. T₀ is aligned with the latest alarm in the figures for simplicity of illustration.

In time axis 204, the entire sequence from X1 to X6 has been observed, wherefore the sequence may be used in a predictor associated with time interval 204T to generate a prediction for alarm A during time interval 204T. As a sequence of six alarms is used to predict A, the prediction may be assigned, for example, a fairly high likelihood.

In time axis 205, the initial part of the sequence, from X1 to X5, has been observed, wherefore the sequence may be used in a predictor associated with time interval 205T to generate a prediction for alarm A during time interval 205T. As a sequence of five alarms is used to predict A, the prediction may be assigned, for example, a fairly high likelihood. The likelihood may nonetheless be lower than for time interval 204T, as only five alarms have been detected, which is a smaller quantity of input data than the six alarms in the case of time interval 204T. For the predictor of time interval 205T, a loopback period from which input data is collected extends from the present time t₀ to a time instant slightly before alarm X1.

In time axis 206, the initial part of the sequence, from X1 to X4, has been observed, wherefore the sequence may be used in a predictor associated with time interval 206T to generate a prediction for alarm A during time interval 206T. As a sequence of four alarms is used to predict A, the prediction may be assigned, for example, a moderate likelihood. The likelihood may be lower than for time interval 205T, as only four alarms have been detected, which is a smaller quantity of input data than the five alarms in the case of time interval 205T. For the predictor of time interval 206T, a loopback period from which input data is collected extends from the present time t₀ to a time instant slightly before alarm X1.

In time axis 207, the initial part of the sequence, from X1 to X3, has been observed, wherefore the sequence may be used in a predictor associated with time interval 207T to generate a prediction for alarm A during time interval 207T. As a sequence of three alarms is used to predict A, the prediction may be assigned, for example, a low likelihood. The likelihood may be lower than for time interval 206T, as only three alarms have been detected, which is a smaller quantity of input data than the four alarms in the case of time interval 206T. For the predictor of time interval 207T, a loopback period from which input data is collected extends from the present time t₀ to a time instant slightly before alarm X1.

In each of the time axes in FIG. 2B, the time period from alarm X1 to the predicted alarm A is constant. Separate predictors are employed for generating predictions of alarm A during the time periods 204T, 205T, 206T and 207T. The separate predictors are separately trained, using separate training data. In detail, initial parts only of the entire sequence {X1, X2, X3, X4, X5, X6} are used in training the predictors for time intervals 205T, 206T and 207T. The farther is the time interval in the future for which predictions are generated, the shorter is the loopback period from which input data is collected, and the shorter are the input sequences used in prediction, and training. In other words, each one of the predictors being configured to predict the networked alarms to occur during a specific, distinct time period occurring in the future, the networked alarm sequences used in the optimization, that is the training, of each one of the predictors are the shorter the further in the future is the specific, distinct time period of the respective predictor.

The predictors may be used simultaneously when performing actual prediction. Thus, an arriving alarm sequence, which is increasing its length as time passes until it is cut using maximum time interval 210, all the trained predictors are produce an inference based on the input. This provides a benefit in terms of being able to predict a specific alarm. For example, a given alarm may have a higher probability to be predicted in a 1-day time horizon, for example 60%, but may have probability to be predicted in a 2-day time horizon as well, for example a likelihood of 30%, and the rest spread over other 4 days. If only a predictor prepared for predicting in the 1-day time horizon were used, up to 40% of valid predictions might be missed.

FIG. 2C illustrates training of the separate predictors. Four predictors are illustrated in FIG. 2C, although the principles of the disclosed technology are not limited to this numerical example. Each one of predictors P0, P1, P2 and P3 is configured to predict, after training, an alarm to take place at a specific time interval, as illustrated in FIG. 2B. For predictor P0, the time interval is in the near future and the entire sequence {X1, X2, X3, X4, X5, X6} is used in the training. For predictor P1, the time interval is farther in the future than in the case of predictor P0, and the a subset of the entire sequence, {X1, X2, X3, X4, X5} is used in the training. For predictor P2, the time interval is farther in the future than in the case of predictor P1, and the a subset of the entire sequence, {X1, X2, X3, X4} is used in the training. For predictor P3, the time interval is farther in the future than in the case of predictor P2, and the a subset of the entire sequence, {X1, X2, X3} is used in the training. The sequences used in training are thus abbreviated to account for the fact that for certain time intervals in the future, the entire sequence will not have had time to be observed. The separate predictors may be trained with a plurality of suitably abbreviated training sequences.

For the training, the training sequences may be expressed in terms of the full feature set or the core feature set. In general, a core feature set may be the same for alarm sequences having the same alarms, but in a different order. In other words, the core feature set may be independent of the order of the alarms in the sequence. This enhances robustness of the prediction process. When the core feature set is used in training, the observed alarms may also be provided to the trained predictors expressed in terms of the core feature set. The full feature set may comprise, in addition to features of the core feature set, for example, the number of alarm activations, their duration and/or the order of the alarms in the sequence.

In some embodiments, training a specific classifier is done for each subsequence, each subsequence amounting to a different full feature set with total activations and total duration.

In an embodiment the alarm full feature set is used as feature set to train the predictors and as feature set for inference as well; the reason is explained hereafter. Initially, an alarm sequence usable in predicting a specific alarm, A, in a specific time interval is sought in the training data. Once the alarm sequence is found, it is selected for use in inference phase for predicting alarm A as occurring soon after the last alarm in the alarm sequence. The sequence is then used in inference phase, and it may be found that instead of occurring soon after the last alarm in the sequence as in the training data, alarm A in inference phase takes place only later, for example at halfway through the overall space of time for which predictions are made. This implies that the sequence of alarms may be suitable for predicting alarm A well into the future. To optimize the predictor, alarm sequences expressed using the same core feature set, but with different full feature sets, can be assessed. For example, for this purpose the core feature set may comprise an alarm type only, and a full feature set may comprise the alarm type, alarm duration and alarm count. A suitable alarm sequence may then be selected for use in predicting alarm A in the inference phase later on. In general, also statistical analysis of alarm patterns in terms of causal chains may be performed, in order to establish the characteristics of patterns suitable to predict the occurrence of alarms in different time intervals in the future. Thus the training data may be optimized, which avoids the problem of having the machine learning classifier train itself into irrelevant aspects of raw training data.

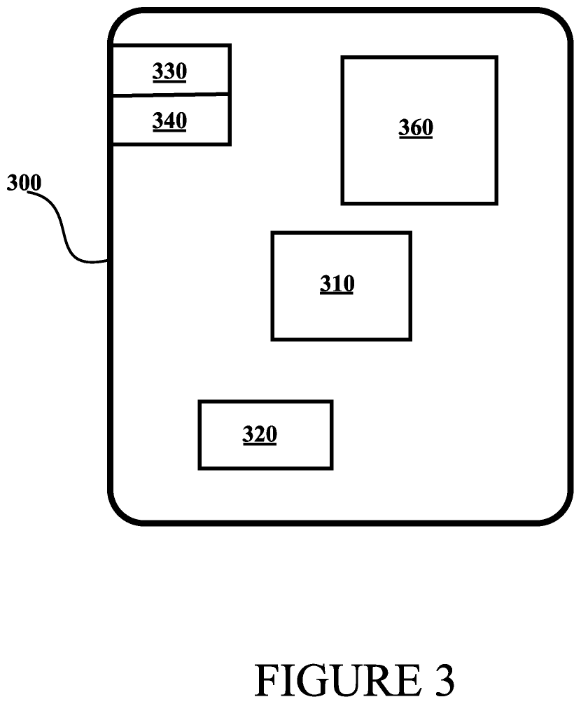

FIG. 3 illustrates an example apparatus capable of supporting at least some embodiments of the present invention. Illustrated is device 300, which may comprise, for example, an FMS 110 of FIG. 1. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Zen processing core designed by Advanced Micro Devices Corporation. Processor 310 may comprise at least one Intel Xeon or AMD Opteron processor. Processor 310 may comprise at least one application-specific integrated circuit, ASIC. Processor 310 may comprise at least one field-programmable gate array, FPGA. Processor 310 may be means for performing method steps in device 300, such as storing, processing, predicting, triggering, transforming and performing. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as fault management system, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance a communication protocol. Transmitter 330 may comprise more than one transmitter. Receiver 340 may comprise more than one receiver. Transmitter 330 and/or receiver 340 may be configured to operate in accordance with a suitable communication standard.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to configure alarm prediction parameter training.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise a fingerprint sensor arranged to authenticate, at least in part, a user of device 300. In some embodiments, device 300 lacks at least one device described above.

Processor 310, memory 320, transmitter 330, receiver 340 and/or UI 360 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

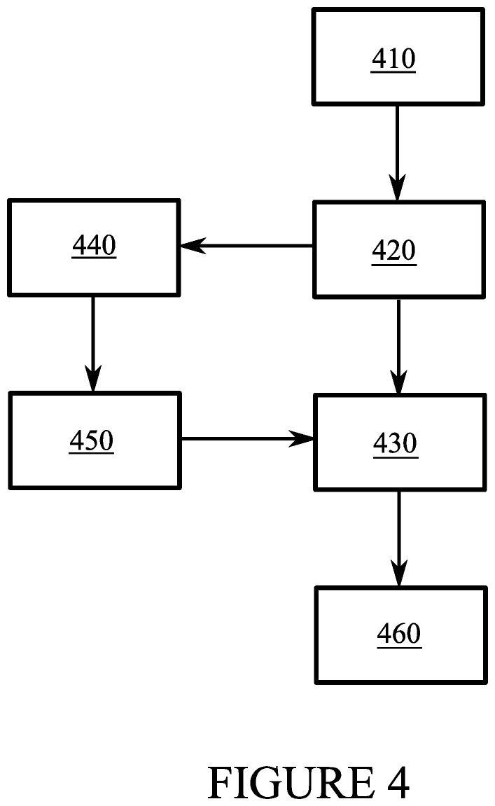

FIG. 4 is a flow chart in accordance with at least some embodiments of the present invention. The chart illustrates phases of time slicing and pattern creation.

Alarm aggregation may be performed into two dimensions: in space, where alarms occurring in the same network element and/or in topologically connected network elements and time, where maximum time interval 210 is used.

Initially, in phase 410, a general loopback period is defined. By loopback period it is meant a time period which is the maximum time difference between a first alarm in an alarm sequence usable in predicting a later alarm, and the occurrence of the later predicted alarm. In essence the loopback period forms the dimension of the time horizon of the machine learning based alarm prediction system.

In phase 420, sequences of alarms are created, amounting to alarm aggregation. Alarm grouping for this purpose may be based on spatial and temporal relations among the alarms in order to identify a potential causal chain with the alarm to be predicted as the last one from the temporal point of view. The grouping in this phase may take place spatially at intra-node level for alarms affecting parts of the same equipment or at inter-node level for alarms of equipment having a known topological or functional relation in the temporal domain as the alarm A, which is to be predicted and provided with a work order or modification instruction. That is, an alarm A tagged with a work order and/or modification instruction is identified in the defined spatial scope, and alarms in the same spatial scope occurring before alarm A are collected until the first alarm separated by its adjacent alarm by more than the maximum time interval 210 of FIG. 2A. This provides a sequence of alarms: X1(TS0), X2(TS1), . . . Xn(TS), A(TS*) where the alarm inter-arrival time (difference between time stamp TS of adjacent alarms) is smaller than the given threshold maximum time interval 210 of FIG. 2A. The maximum of the difference TS*-TS0 for alarms in the training data is the loopback period, LP. In the first sequence delineation phase, the General Loopback Period GPL may be used.

In phase 430, time slicing is performed. This refers to creation of the plural time intervals for which separate predictions are to be generated, using respective separate machine learning-based predictors to be trained using the training data. Phase 430 takes input from phases 420 and 450.

In phase 440, taking input from phase 420, base statistics of delineate subsequences are calculated; for example, the distribution of length of causal alarm chains. This is useful since allows for determining which is the maximum time horizon of prediction; for example, if a maximum length of a chain is 7 days it is clear that no valuable prediction beyond 7 day can be provided; this defines a maximum prediction time horizon. In addition, observing the distribution can be decided a time slicing/time discretization step to be used for “blind period”.

In phase 450, a blind period step is obtained. The blind period step is another term for a quantization step in this process. BLIND_PERIOD[i]: i*QUANTIZATION_STEP with i in the range [0, M]. The quantization step refers to the length of time intervals into which the “Max Prediction Time Horizon” is subdivided. With a given blind period the considered alarm sequence may span (from past to future) in the range [T₀-LP, T₀-BLIND_PERIOD]. A BLIND_PERIOD[i] is so defined for each one of the M problems of prediction as the period from which the respective alarm sequence will not yet have had time to arrive. For example, in FIG. 2A, time axis 203.1, alarms X3 and X4 are in the blind period with respect to time interval 2G. Observing the distribution and Max Prediction Time Horizon, a time slicing/time discretization step may be performed to be used for the blind period and provide calculated blind period and intervals to phase 430 that execute time slicing/discretization.

In phase 460 a new alarm sequence is created with different blind period. This for each one of the distinct predictors for the respective time intervals for which separate predictions are generated, appropriately truncated versions of the alarm sequences {X1, X2, X3, X4} are generated, taking into account that when the time interval is in the future, not all of the alarms in the sequence will have had time to occur.

Statistics about lengths of subsequences may be used in inference mode so that each classifier, associated with a given blind period, delineates input sequences, received in an online mode, using as maximum loopback the statistics calculated after time/slicing discretization of complete sequences (e.g. median or 3^{rd} quartile) and maximum time interval 210 as a cutoff criteria. Those statistics are calculated in block 460.

The system may be configured to define a Maximum Prediction Time Horizon. Users may configure a Prediction Time Horizon which is different from Maximum Prediction Time Horizon. If the configured Prediction Time Horizon is longer than Maximum Prediction Time Horizon, prediction performances may be hampered since the system will predict many false positives, not being in a position to make predictions for alarms that will occur between Maximum Prediction Time Horizon and the configured Prediction Time Horizon, since not causal relation exists.

The system may be configured to calculate an Optimal Prediction Time Horizon, which optimizes prediction performance. In the following, we assume that an initial Prediction Time Horizon is equal or less than Maximum Prediction Time Horizon, in the example we assume they are equal. A system with a Maximum Prediction Time Horizon of 10 days may have 10 predictors, each one with its own blind period.

In the following, the following definitions apply: prediction performances, where different metrics can be used. A non-limiting example is the F1 Score among precision and recall. Cumulative pattern distribution is a cumulative of distribution of pattern length. Two method are now presented:

Firstly, method 1: a percentile of the Cumulative Pattern Distribution is selected, e.g., 75^{th} percentile and the length of patterns in correspondence to the 75^{th} percentile become the Optimal Prediction Time Horizon.

Secondly, method 2: Performance applying only 1^{st} blind period is calculated, that is, only Predictor 1 is used to obtain Predictor 1 Performance. Then Performance applying 1^{st} and 2^{nd} blind period is calculated, that is Predictor 1 and Predictor 2 are used and obtain Predictor 1 Performance and Predictor 2 Performance, and so on until all predictors are characterized. Then the optimal maximum blind period is found in correspondence of one of the steps among calculating of the blind periods. For instance, the maximum blind period may be 6 days; this means that only Predictors from 1 to 6 are used for Optimal Performance and the Optimal Prediction Time Horizon is 6 days, for example.

The algorithms works because adding more predictors the amount of predictions increases thus increasing the recall; at the same time going towards longer blind periods the prediction horizon increases and the length of the considered alarm subsequence decreases increasing the number of false positives, wherefore optimal performance is obtained somewhere in between zero blind period and a maximum feasible blind period.

Recapitulating, the process overall may be seen in the following stages. Firstly, initial analysis where a “general loopback period” named GLP is defined to delineate alarm sequence of interest from alarm input stream. Secondly, each sequence is read and a cutoff is determined by maximum time interval 210. From this, the longest alarm sequence length is determined as Max Chain Length. Thirdly, base statistics of delineated subsequences may be calculated; for instance the length distribution of alarm sequences. This is useful since it allows for determining which is the maximum time horizon of prediction; for example, if Max Chain Length of a sequence is 7 days it is clear that no valuable prediction beyond 7 day can be provided; this defines a Maximum Prediction Time Horizon. In addition, observing the distribution and Maximum Prediction Time Horizon can be decided a time slicing/time discretization step to be used for the blind period.

Fourthly, the observed alarm sequences may be used to start a time slicing/discretization process that discretizes a sequence that can be as long as Max Chain Length is applied starting from the complete sequence ending in the predicted alarm A, and progressively removing alarms starting from A in a backward direction according to a discretization step that is also called “blind period” until Maximum Prediction Time Horizon. Fifthly, for each blind period, statistics on the length of sub-sequences may be calculated as, for example, mean, median, quartiles. Sixthly, for each sub-sequence that corresponds to a specific blind period, the full feature set is obtained. Each classifier corresponding to a given “blind period” can be trained with full summarization of subsequences obtained by the discretization process at the same blind period step.

Statistics about lengths of subsequences may be used in inference mode so that each classifier, associated with a given blind period, accepts input sequences, received in online mode, using as maximum loopback the statistics calculated after time/slicing discretization of complete sequences (e.g. median or 3^{rd} quartile), and maximum time interval 210 as a cutoff criterion. This maximum loopback is characteristic of each blind period for each predictor calculated by block 460.

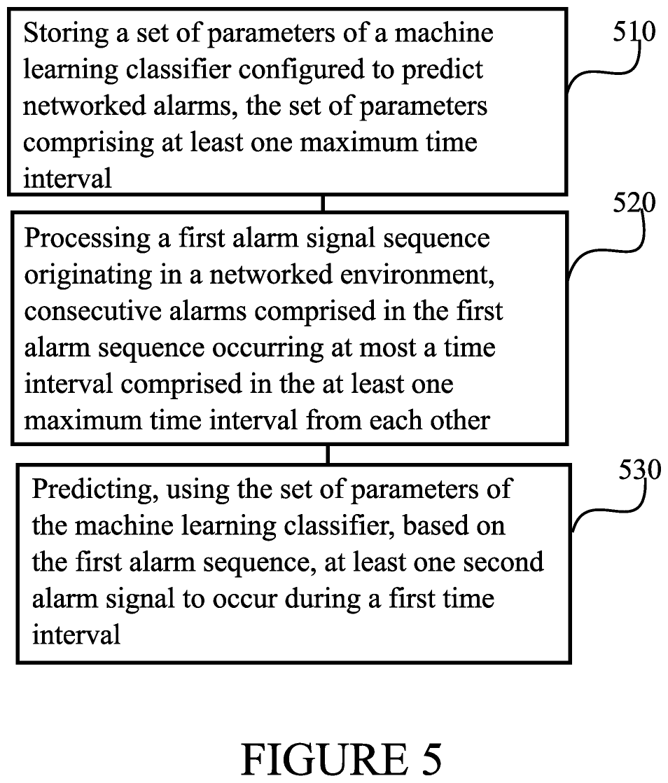

FIG. 5 is a flow graph of a method in accordance with at least some embodiments of the present invention. The phases of the illustrated method may be performed in FMS 110, for example, or in a control device configured to control the functioning thereof, when installed therein.

Phase 510 comprises storing, in an apparatus, a set of parameters of a machine learning classifier configured to predict networked alarms, the set of parameters comprising at least at least one maximum time interval. Phase 520 comprises processing a first alarm signal sequence originating in a networked environment, consecutive alarms comprised in the first alarm signal sequence occurring at most a time interval comprised in the at least one maximum time interval from each other. Finally, phase 530 comprises predicting, using the set of parameters of the machine learning classifier and the machine learning classifier itself, based on the first alarm signal sequence, at least one second alarm signal to occur during a first time interval.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in managing networked environments, such as communication networks, for example.

### Acronyms List

AMF access and mobility management functions
CAR classifier based on associative rules
LP loopback period
LTE long term evolution
MME mobility management entity
SGSN serving general packet radio service support nodes
TS time stamp
VNF virtualized network function
WiMAX worldwide interoperability for microwave access
WCDMA wideband code division multiple access
WLAN wireless local area network

REFERENCE SIGNS LIST

| | |
|---|---|
| 102 | base stations |
| 104, 105, 108 | core network nodes |
| 110 | fault management system |
| 120 | core network |
| 201, 202, 203 | time axes |
| 210 | maximum time interval |
| 220 | time interval |
| 2A, 2B, 2C, | time intervals |
| 2D, 2E, 2F, | |
| 2G, 2H | |
| 300-306 | structure of the device of FIG. 3 |
| 410-460 | phases of the process of FIG. 4 |
| 510-530 | phases of the method of FIG. 5 |

1-31. (canceled)

32. An apparatus comprising at least one processing core, at least one memory including computer program code, the at least one memory and the computer program code being configured to, with the at least one processing core, cause the apparatus at least to:
store a set of parameters of a machine learning classifier configured to predict networked alarms, the set of parameters comprising at least one maximum time interval;
process a first alarm signal sequence originating in a networked environment, consecutive alarms comprised in the first alarm signal sequence occurring at most a time interval comprised in the at least one maximum time interval from each other, and
predict, using the set of parameters of the machine learning classifier and the machine learning classifier, based on the first alarm signal sequence, at least one second alarm signal to occur during a first time interval.

33. The apparatus according to claim 32, wherein the least one memory and the computer program code are configured to, with the at least one processing core, cause the apparatus to predict, based on a subset of the first alarm signal sequence, the at least one second alarm signal to occur during a second time interval, which begins later than the first time interval, the apparatus being configured to perform the predicting based on the subset of the first alarm sequence at a time instant when an overall time duration of the first alarm sequence, starting from a first one of alarms in the first alarm sequence, has not yet elapsed.

34. The apparatus according to claim 33, wherein a last alarm of each first subsequence has a different distance in time from the at least one second alarm signal to occur during a second time interval to predict, and the apparatus is configured to use each subsequence to train a different predictor, wherein the apparatus is configured to use each predictor is after training to predict the same at least one second alarm signal to occur during a second time interval.

35. The apparatus according to claim 32, wherein the least one memory and the computer program code are configured to, with the at least one processing core, cause the apparatus to trigger an action responsive to predicting the at least one second alarm, wherein the triggered action comprises a modification in the networked environment to prevent the at least one second alarm from occurring, or transmission of a work order to fix a cause of the at least one second alarm signal.

36. The apparatus based on claim 35, wherein the least one memory and the computer program code are configured to, with the at least one processing core, cause the apparatus to trigger the action automatically without human operator intervention.

37. The apparatus according to claim 32, wherein the machine learning classifier comprise a classifier based on associative rules.

38. The apparatus according to claim 32, wherein the least one memory and the computer program code are configured to, with the at least one processing core, cause the apparatus to update at least a part of the parameters of a machine learning classifier based on patterns in alarm signals received in the apparatus.

39. The apparatus according to claim 32, wherein the least one memory and the computer program code are configured to, with the at least one processing core, cause the apparatus to transform the first alarm signal sequence into an invariant part which is not predictive of a time instant when the at least one second alarm signal occurs and a variant part which is predictive of the time instant when the at least one second alarm signal occurs.

40. The apparatus according to claim 32, wherein the least one memory and the computer program code are configured to, with the at least one processing core, cause the apparatus to perform the prediction of the at least one second alarm signal such that the apparatus generates separate predictions for each of a plurality of future time intervals concerning the occurrence of the at least one second alarm signal.

41. The apparatus according to claim 40, wherein the least one memory and the computer program code are configured to, with the at least one processing core, cause the apparatus to assign to each one of the separate predictions an individual likelihood of the predicted at least one second alarm signal occurring during the respective future time interval.

42. A method comprising:
storing, in an apparatus, a set of parameters of a machine learning classifier configured to predict networked alarms, the set of parameters comprising at least one maximum time interval;
processing a first alarm signal sequence originating in a networked environment, consecutive alarms comprised in the first alarm signal sequence occurring at most a time interval comprised in the at least one maximum time interval from each other, and
predicting, using the set of parameters of the machine learning classifier and the machine learning classifier, based on the first alarm signal sequence, at least one second alarm signal to occur during a first time interval.

43. The method according to claim 42, further comprising predicting, based on a subset of the first alarm signal sequence, the at least one second alarm signal to occur during a second time interval, which begins later than the first time interval, the apparatus being configured to perform the predicting based on the subset of the first alarm sequence at a time instant when an overall time duration of the first alarm sequence, starting from a first one of alarms in the first alarm sequence, has not yet elapsed.

44. The method according to claim 42, further comprising triggering an action responsive to predicting the at least one second alarm, wherein the triggered action comprises a modification in the networked environment to prevent the at least one second alarm from occurring, or transmission of a work order to fix a cause of the at least one second alarm signal.

45. The method according to claim 42, wherein an individual likelihood of the predicted at least one second alarm signal occurring during the respective future time interval is assigned to each one of the separate predictions.
